(19) United States
(12) Patent Application Publication
(10) Pub. No.: US 2010/0175501 A1
(43) Pub. Date: Jul. 15, 2010

(54) Effort-Saving Cam Device of Hinge Assembly for Electronic Device

(76) Inventor: Chao-Chi Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/352,663

(22) Filed: Jan. 13, 2009

(51) Int. Cl. F16H 53/06

(52) U.S. Cl. 74/569

(57) ABSTRACT

A hinge assembly includes a cam device and a pintle inserted through the cam device. The cam device includes first and second cam members. The first cam member includes a recess inset on a side thereof and the second cam member includes a protrusion with a shape substantially corresponding to the recess. The protrusion is selectively positionable in the recess and moveable on the side of the first cam member. The recess is configured with first and second guiding sections, and the second guiding section is offset from the side at a first angle, and the first guiding section offset from the side at a second angle, and the second angle greater than the first angle such that the protrusion can be operably moved out of the recess with effort-saving effect.

### BACKGROUND OF THE INVENTION

1. Field of the Invention

The present invention relates to a cam device which is incorporated in a hinge assembly for an electronic device and, in particular, to a cam device which is effort-saving during operation thereof.

2. Description of the Related Art

Taiwan Patent No. M244497 disclose a hinge assembly for an electronic device having a cam device. With the cam device, the hinge assembly can support a base and a cover of the electronic device at various opening positions. As set forth in this patent, the cam device includes a cam member and a cam follower rotatable relative to the cam member. Additionally, the cam member includes a recess and the cam follower includes a protrusion that is adapted to be rotated to engage with the recess partially or completely and is adapted to be rotated to disengage with the recess. Typically, when the protrusion is completely received in the recess, the hinge assembly is at a position such that the electronic device is closed. Further, to open the electronic device, the protrusion is gradually rotated out of the recess. But a drawback is that user has to do effort to rotate the protrusion out of the recess.

The present invention is, therefore, intended to obviate or at least alleviate the problems encountered in the prior art.

### SUMMARY OF THE INVENTION

According to the present invention, a cam device which is incorporated in a hinge assembly includes first and second cam members. The first cam member includes a recess inset on a side thereof. The second cam member includes a protrusion with a shape substantially corresponding to the recess. The protrusion is selectively positionable in the recess and moveable on the side of the first cam member. The recess is configured with first and second guiding sections, and the second guiding section is offset from the side at a first angle, and the first guiding section offset from the side at a second angle, and the second angle greater than the first angle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a perspective view of a cam device in accordance with the present invention.

FIG. 2 is an exploded perspective view of the cam device shown in FIG. 1.

FIG. 3 is a side view of a first cam member of the cam device shown in FIG. 1.

FIG. 3a is a cross-sectional view taken along line 3a-3a of FIG. 3.

FIG. 4 is a side view of a second cam member of the cam device shown in FIG. 1.

FIG. 4a is a cross-sectional view taken along line 4a-4a of FIG. 4.

FIG. 5 is a side view of the cam device shown in FIG. 1.

FIG. 6 is a cross-sectional view taken along line 6-6 of FIG. 5.

FIG. 7 is a cross-sectional view taken along line 7-7 of FIG. 6.

FIG. 8 is a partial, enlarged view of the cam device shown in FIG. 7.

FIG. 9 is a cross-sectional view similar to FIG. 7, but shows the first cam member is in another position with respect to the second cam member.

FIG. 10 is a partial, enlarged view of the cam device shown in FIG. 9

FIG. 11 is a cross-sectional view similar to FIG. 9, but shows the first cam member is in another position with respect to the second cam member.

FIG. 12 is a partial, enlarged view of the cam device shown in FIG. 11.

FIG. 13 is a cross-sectional view similar to FIG. 11, but shows the first cam member is in another position with respect to the second cam member.

FIG. 14 is a partial, enlarged view of the cam device shown in FIG. 13.

FIG. 15 is a cross-sectional view similar to FIG. 13, but shows the first cam member is in another position with respect to the second cam member.

### DETAILED DESCRIPTION OF THE PREFERRED EMBODIMENT

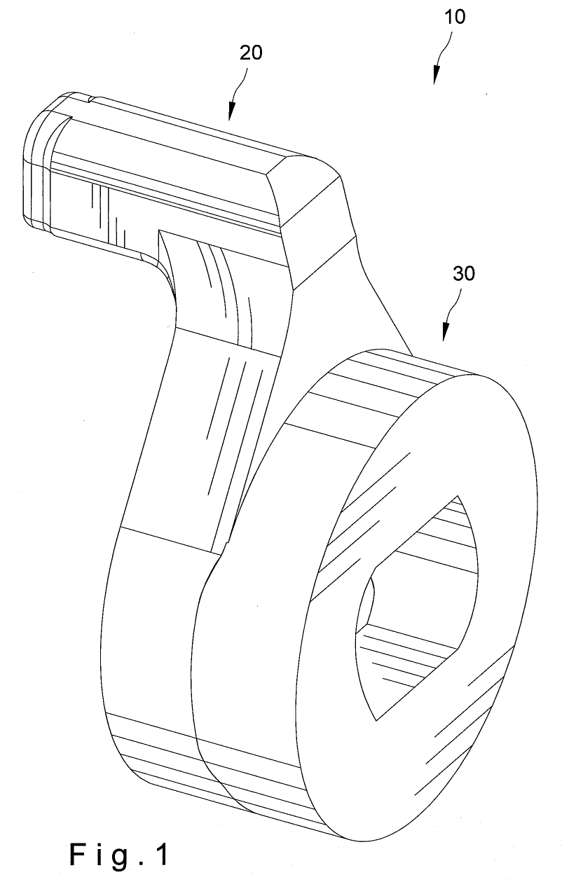

FIG. 1 shows a cam device 10 which is incorporated in a hinge assembly (not shown) includes first and second cam members 20, 30. Typically, the hinge assembly includes a pintle inserting through the first and second cam members 20, 30.

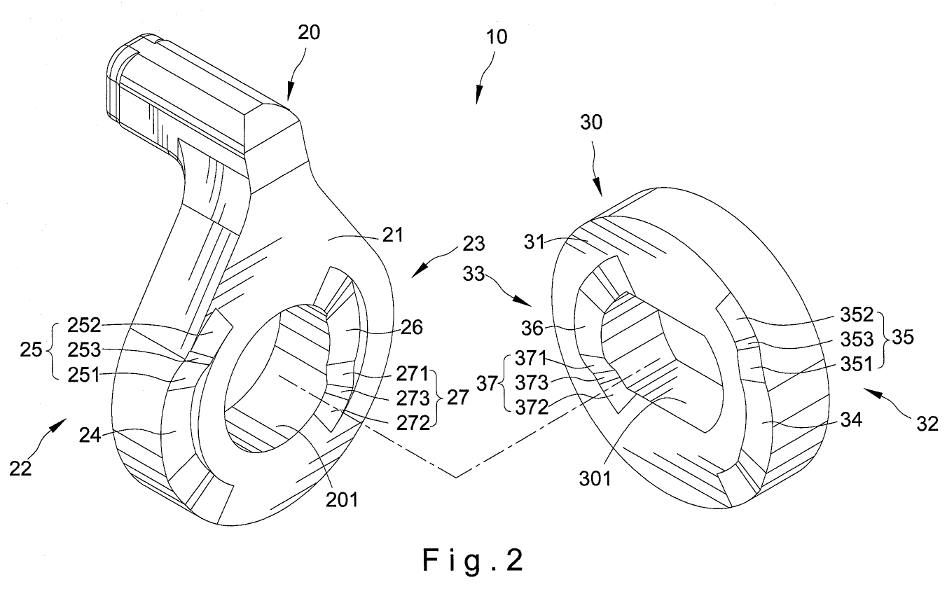

As shown in FIG. 2, the first cam member 20 includes a hole 201 therethrough, and the pintle is adapted to be inserted through the hole 201; the second cam member 30 includes a hole 301 therethrough, and the pintle is adapted to be inserted through the hole 301.

One of the first and second cam members 20, 30 is rotatable with respect to the pintle, and the other of the first and second cam members 20, 30 is axially moved on the pintle. In this embodiment, the first cam member 20 is rotatable with respect to the pintle, and the hole 201 is substantially circular such that the first cam member 20 is rotatable with respect to the pintle; the second cam member 30 is axially moved on the pintle and is restrained from rotation with respect to the pintle, and the hole 301 includes two straight peripheral edges such that the second cam member 30 is restrained from rotation with respect to the pintle.

As also shown in FIG. 2, the first cam member 20 includes two recesses 22 and 23 inset on a side 21 thereof. The recess 22 includes a bottom edge 24 and two guiding edges 25 extending between two ends of the bottom edge 24 and the side 21. The recess 23 includes a bottom edge 26 and two guiding edges 27 extending between two ends of the bottom edge 26 and the side 21. The guiding edge 25 includes first and second guiding sections 251 and 252. A turning section 253 may be formed between the first and second guiding sections 251 and 252. Preferably, the turning section 253 is arcuate. The first guiding section 251 interconnects the bottom edge 24 and the turning section 253. The second guiding section 252 interconnects the turning section 253 and the side 21. Likewise, the guiding edge 27 includes first and second guiding sections 271 and 272. A turning section 273 may be formed between the first and second guiding sections 271 and 272. Preferably, the turning section 273 is arcuate. The first guiding section 271 interconnects the bottom edge 26 and the turning section 273. The second guiding section 272 interconnects the turning section 273 and the side 21. Moreover, the recesses 22 and 23 are radially disposed with respect to the hole 201. In this embodiment, the recess 22 is spaced from the hole 201 while the recess 23 has a periphery coinciding with the hole 201. Further, the two recesses 22 and 23 are opposite to each other, and the hole 201 is intermediate the two recesses 22 and 23.

The second cam member 30 includes two protrusions 32 and 33 inset on a side 31 thereof. The protrusion 32 has a shape substantially corresponding to the recess 22 and the protrusion 33 has a shape substantially corresponding to the recess 23. The protrusion 32 includes a top edge 34 and two engaging edges 35 extending between two ends of the top edge 34 and the side 31. The protrusion 33 includes a top edge 36 and two engaging edges 37 extending between two ends of the top edge 36 and the side 31. The engaging edge 35 includes first and second engaging sections 351 and 352. A turning edge 353 may be formed between the first and second engaging sections 351 and 352. Preferably, the turning edge 353 is arcuate. The first engaging section 351 interconnects the top edge 34 and the turning edge 353. The second engaging section 352 interconnects the turning edge 353 and the side 31. Likewise, the engaging edge 37 includes first and second engaging sections 371 and 372. A turning edge 373 may be formed between the first and second engaging sections 371 and 372. Preferably, the turning edge 373 is arcuate. The first engaging section 371 interconnects the top edge 36 and the turning edge 373. The second engaging section 372 interconnects the turning edge 373 and the side 31. Moreover, the protrusions 32 and 33 are radially disposed with respect to the hole 301. In this embodiment, the protrusion 32 is spaced from the hole 301 while the protrusion 33 has a periphery coinciding with the hole 301. Further, the two protrusions 32 and 33 are opposite to each other, and the hole 301 is intermediate the two recesses 22 and 23.

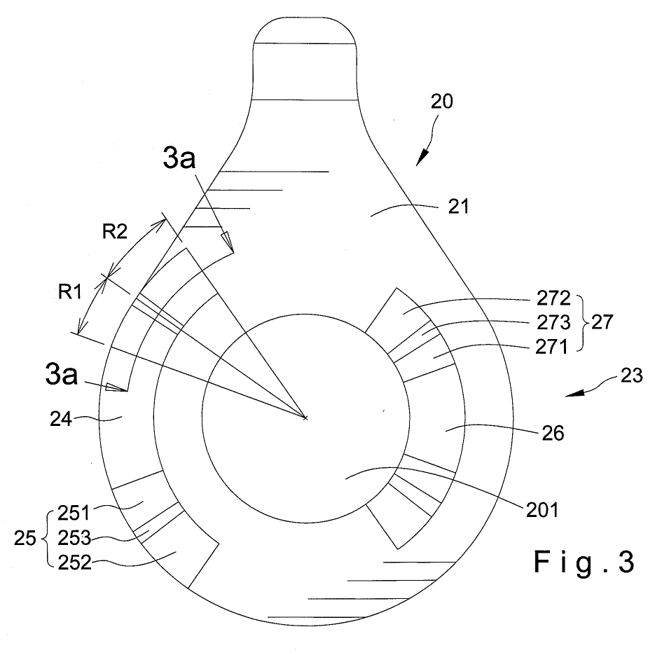

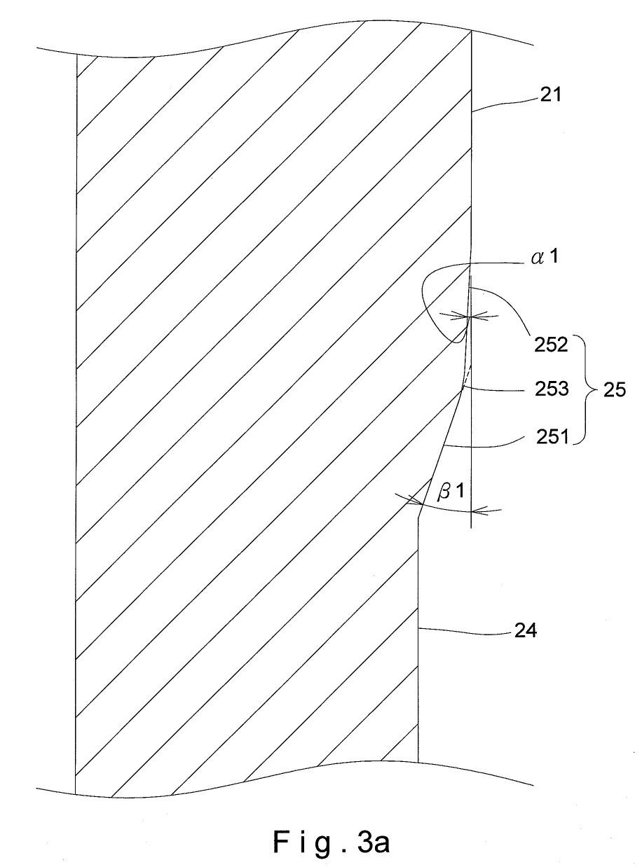

FIG. 3 shows that the hole 201 on the first cam member 20 defines an imaginary point O. The first guiding section 251 and a substantially half turning section 253 define a first length of circumference R1 with respect to the imaginary point O. The second guiding section 252 and a substantially half turning section 253 define a second length of circumference R2 with respect to the imaginary point O. The second length of circumference R2 is greater than the first length of circumference R1. Preferably, the second length of circumference R2 has a central angle substantially equals to 20 degree.

FIG. 3a shows that the second guiding section 252 is offset from the side 21 at a first angle α1 and the first guiding section 251 is offset from the side 21 at a second angle β1. The second angle β1 is greater than the first angle α1. Although not shown, it is understood that the same configuration applies to the first and second guiding sections 271 and 272.

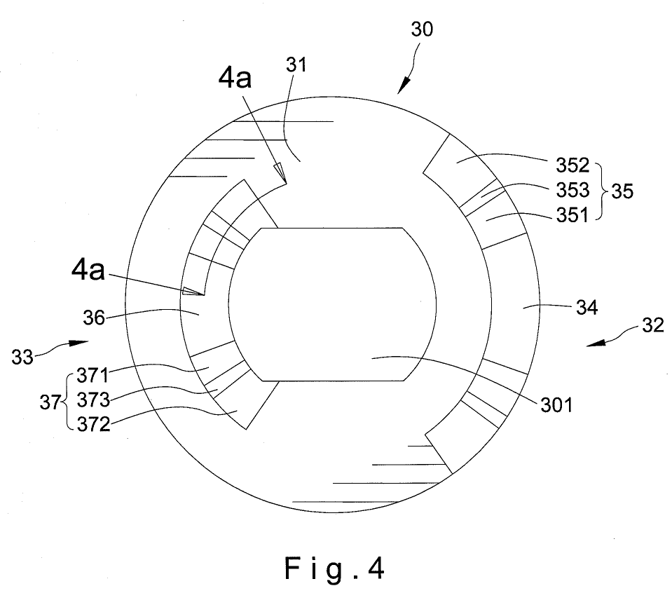

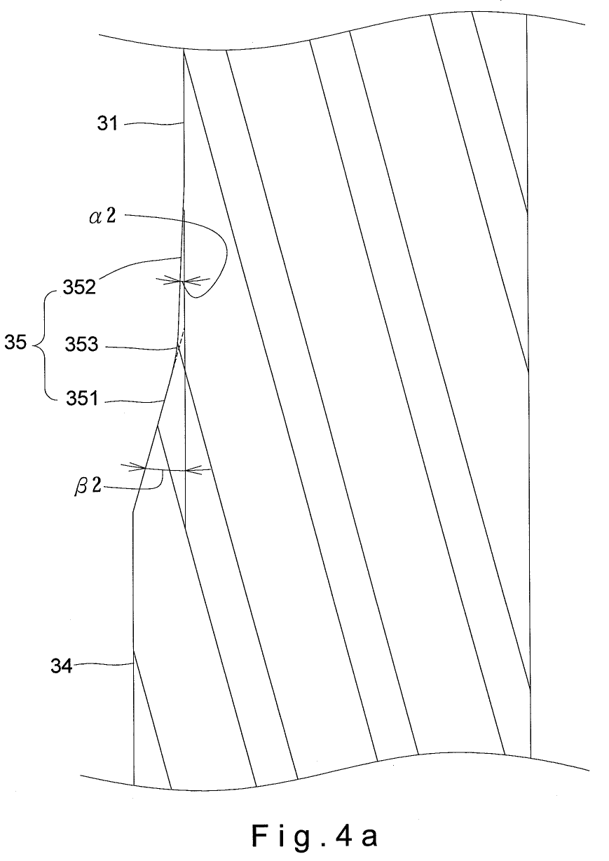

FIG. 4a shows that the second engaging section 352 is offset from the side 31 at a third angle α2 and the first engaging section 351 is offset from the side 31 at a fourth angle β2. The fourth angle β2 is greater than the third angle α2. Although not shown, it is understood that the same configuration applies to the first and second engaging sections 371 and 372.

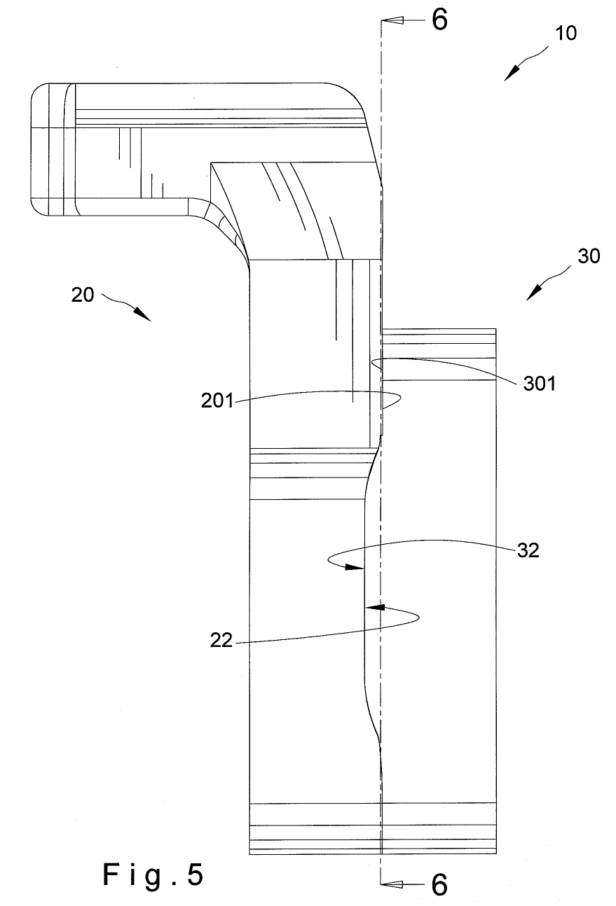

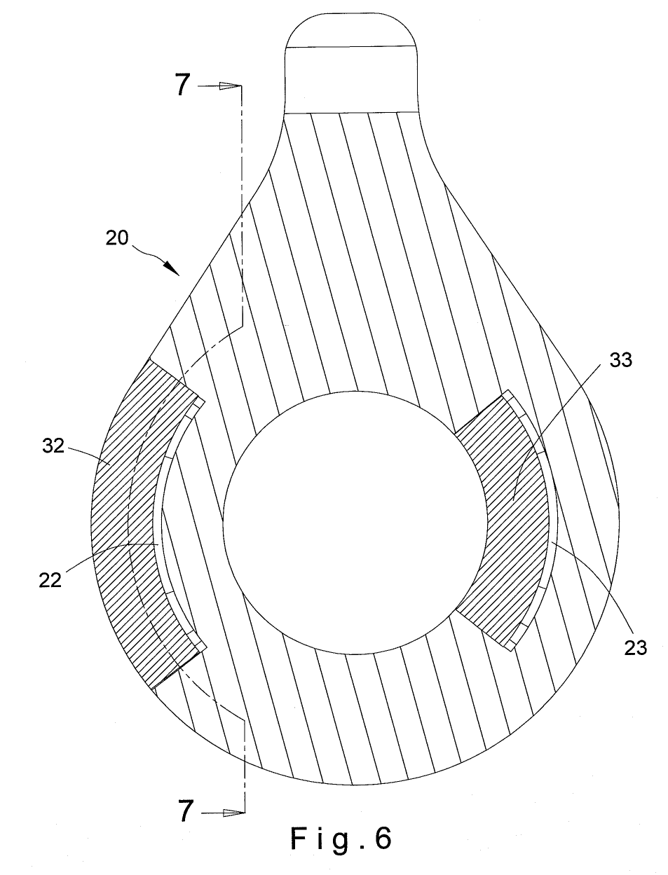

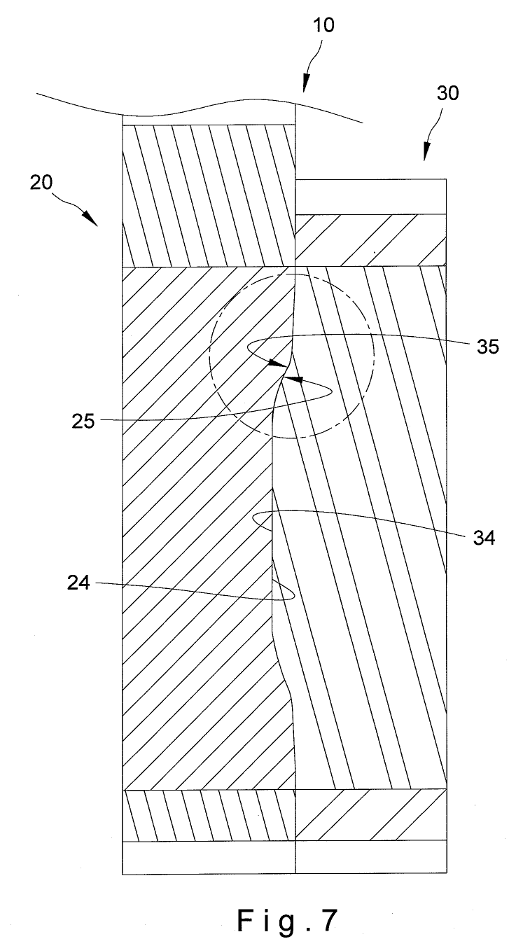

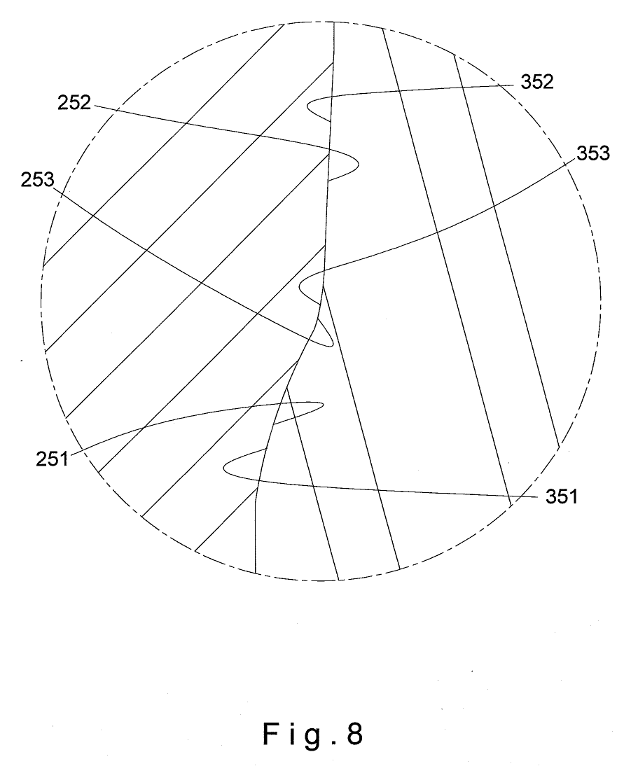

Referring to FIGS. 5 through 8, the protrusion 32 is receivable in the recess 22 and the protrusion 33 is receivable in the recess 23, respectively. Moreover, the first guiding section 251 and the first engaging section 351 are engaged with each other, the second guiding section 252 and the second engaging section 352 are engaged with each other, and the third guiding section 253 and the third engaging section 353 are engaged with each other.

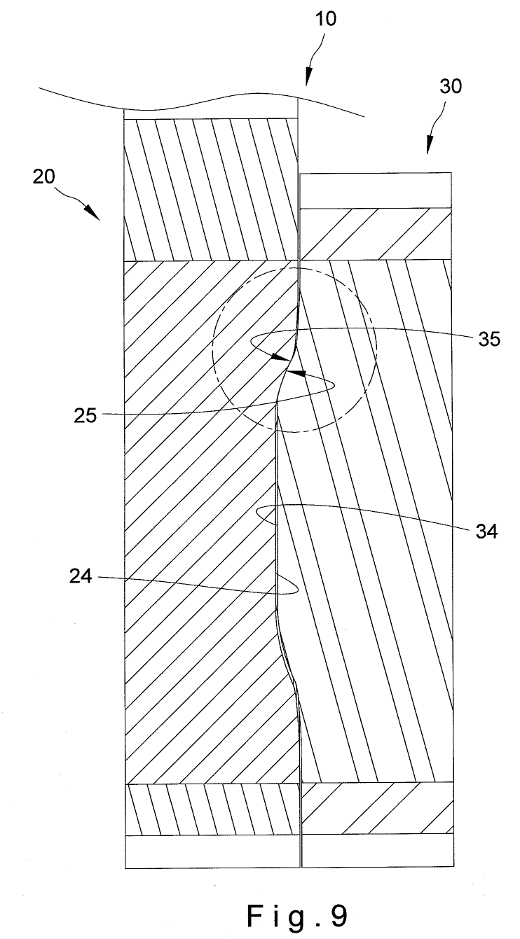

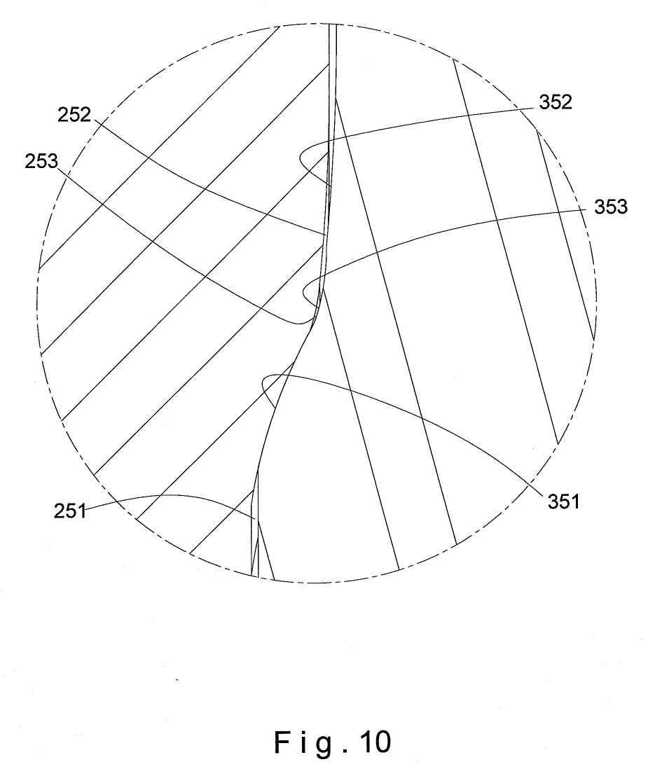

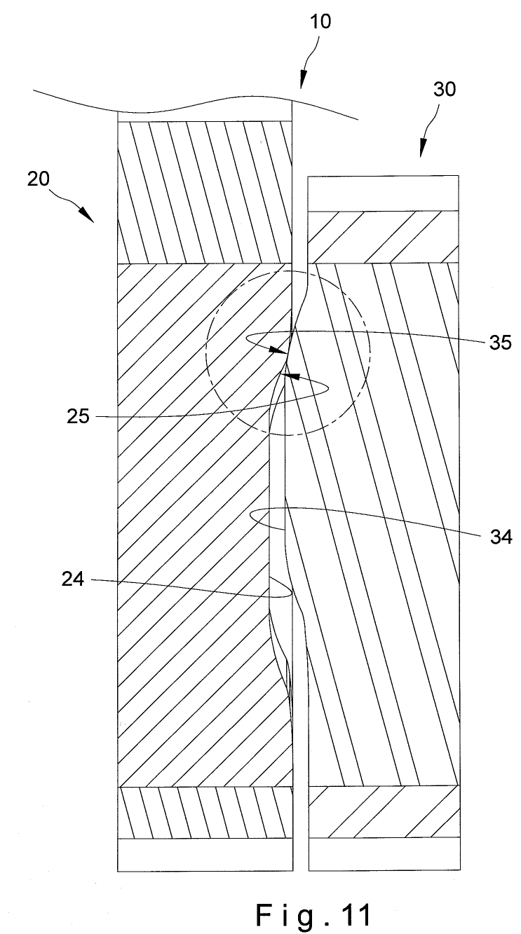

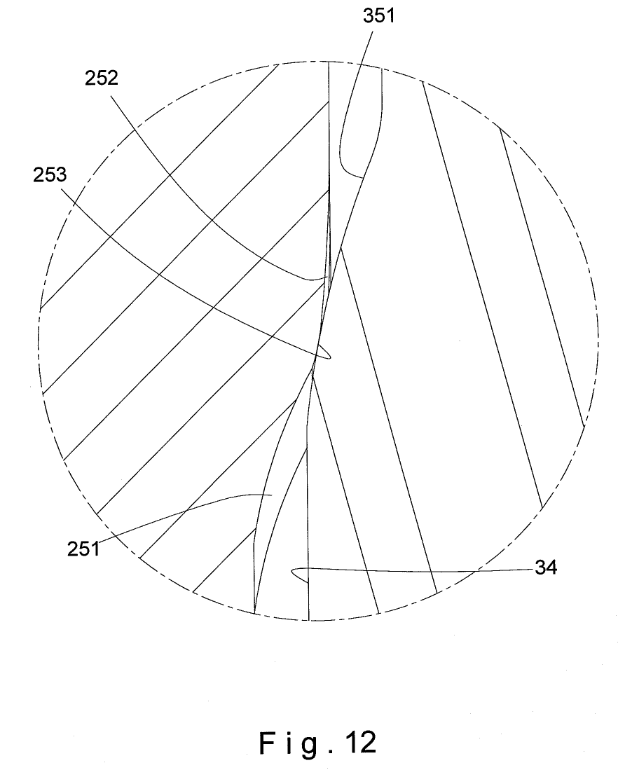

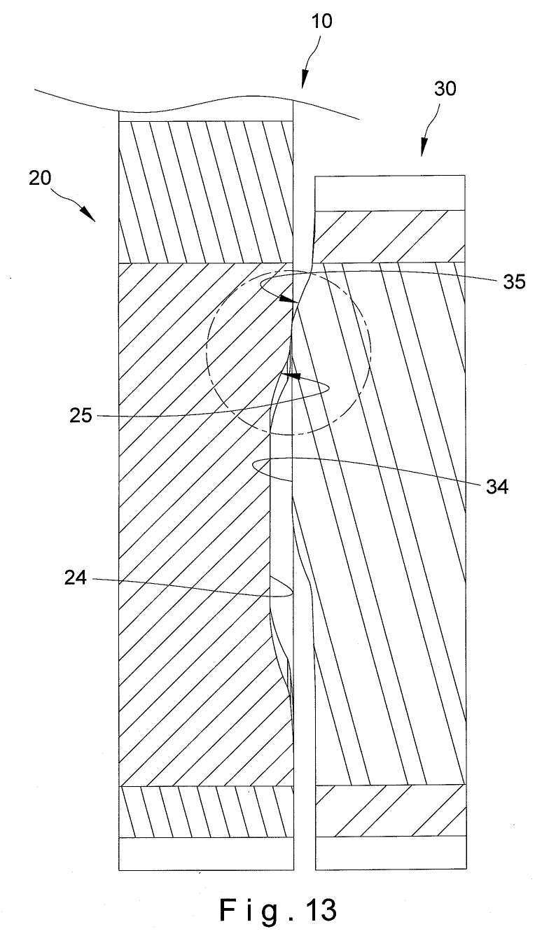

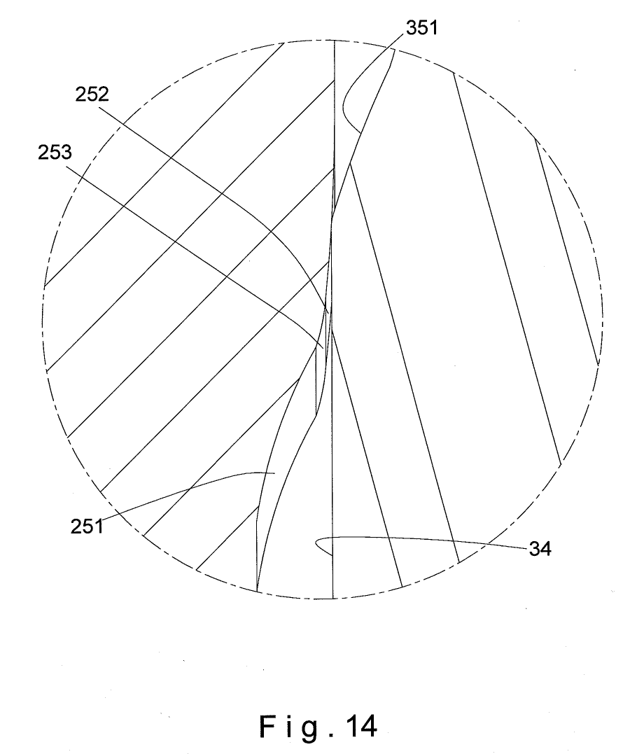

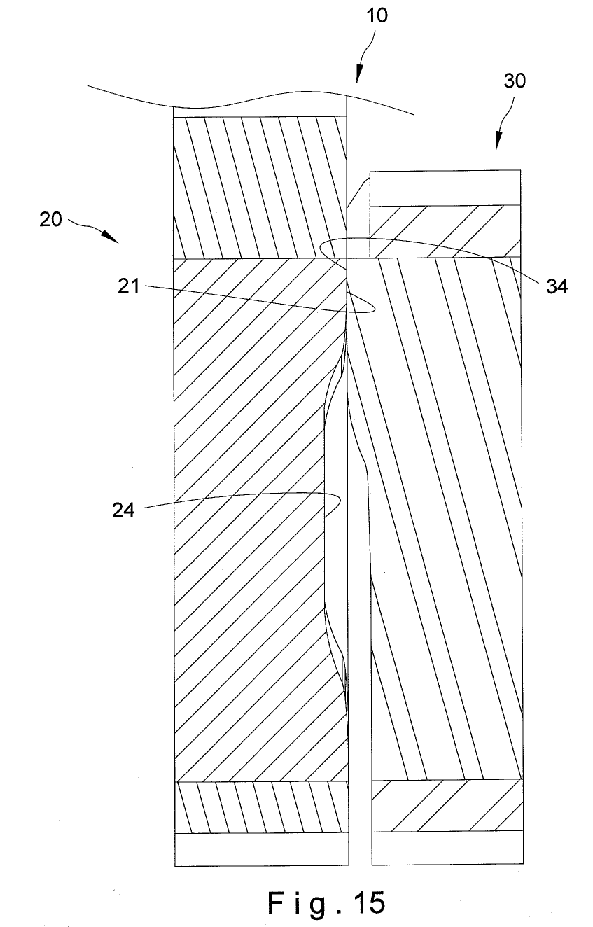

Referring to FIGS. 9 through 15, when the first cam member 20 is rotated, the protrusion 32 is adapted to be rotated out of the recess 22 and moved on the side 21. Likewise, the protrusion 33 is adapted to be rotated out of the recess 23 and moved on the side 21.

Based on the forgoing, it is an objective of the present invention that the turning sections 253 and 273 and the turning edge 353, 373 are arcuate, so that when the protrusion 32 is rotated from the first guiding section 251 to the second guiding section 252 the protrusion 32 is in smooth transition. Likewise, when the protrusion 33 is rotated from the first guiding section 271 to the second guiding section 272 the protrusion 33 is in smooth transition.

It is another objective of the present invention that the second guiding sections 252 facilitates user to rotate the protrusion 32 out of the recess 22 while the first guiding sections 251 facilitates user to move the protrusion 32 in the recess 22. Likewise, it is understood that the second guiding sections 272 of the guiding edge 27 facilitates user to rotate the protrusion 33 out of the recess 23 while the first guiding section 271 facilitates user to move the protrusion 33 in the recess 23.

It is a further objective of the present invention that the second length of circumference R2 is greater than the first length of circumference R1 so as to facilitate user to move the protrusion 32 out of the recess 22 and the protrusion 33 out of the recess 23, respectively.

While the specific embodiments have been illustrated and described, numerous modifications come to mind without significantly departing from the spirit of invention and the scope of invention is only limited by the scope of accompanying claims.

What is claimed is:

1. A cam device is incorporated in a hinge assembly, with the hinge assembly including a pintle inserting through the cam device, and the cam device comprising:
a first cam member including a recess inset on a side thereof; the recess including a bottom edge below the side and two guiding edges extending between two ends of the bottom edge and the side respectively, each of the guiding edge including first and second guiding sections, with the second guiding section offset from the side at a first angle, with the first guiding section offset from the side at a second angle, and with the second angle greater than the first angle; and
a second cam member including a protrusion on a side thereof, with the protrusion having a shape substantially corresponding to the recess, and with the protrusion selectively positionable in the recess and moveable on the side of the first cam member.

2. The cam device as claimed in claim 1 wherein the protrusion includes a top edge above the side and two engaging edges extending between two ends of the top edge and the side respectively, each of the engaging edge including first and second engaging sections, with the second engaging section offset from the side at a third angle, with the first engaging section offset from the side at a fourth angle, and with the fourth angle greater than the third angle.

3. The cam device as claimed in claim 2 wherein the recess includes a turning section formed between the first and second guiding sections, with the turning section being arcuate, and wherein the protrusion includes a turning edge formed between the first and second engaging sections, with the turning edge being arcuate.

4. The cam device as claimed in claim 1 wherein the first and second cam members include two holes through which the pintle is inserted respectively, and wherein the recess is radially disposed with respect to the hole on the first cam member, and wherein the protrusion is radially disposed with respect to the hole on the second cam member.

5. The cam device as claimed in claim 4 wherein the hole on the first cam member defines an imaginary point, and wherein each first guiding section and a substantially half third guiding section define a first length of circumference with respect to the imaginary point, and wherein each second guiding section and a substantially half third guiding portion define a second length of circumference with respect to the imaginary point, and with the second length of circumference greater than the first length of circumference.

6. The cam device as claimed in claim 5 wherein the second length of circumference has a central angle substantially equals to 20 degree.

7. The cam device as claimed in claim 4 wherein the number of the recesses is two, and wherein one of the two recesses has a periphery coinciding with the hole on the first cam member, and wherein the other of the two recesses is spaced from the hole on the first cam member.

8. The cam device as claimed in claim 4 wherein the number of the recesses is two, and wherein the two recesses are opposite to each other, and wherein the hole on the first cam member is intermediate the two recesses.

9. The cam device as claimed in claim 7 wherein the number of the recesses is two, and wherein the two recesses are opposite to each other, and with the hole on the first cam member intermediate the two recesses.

10. The cam device as claimed in claim 2 wherein the number of the protrusions is two, and wherein one of the two protrusions has a periphery coinciding with the hole on the second cam member, and wherein the other of the two protrusions is spaced from the hole on the first cam member.

11. The cam device as claimed in claim 10 wherein the number of the protrusions is two, and wherein the two protrusions are opposite to each other, and with the hole on the second cam member intermediate the two protrusions.
